(19) United States
(12) Patent Application Publication
(10) Pub. No.: US 2025/0297164 A1
(43) Pub. Date: Sep. 25, 2025

(54) PYROLYSIS SYSTEM FOR PRODUCTION OF HYDROCARBON COMPOUNDS FROM RESIDUAL PLASTIC PRODUCTS

(71) Applicant: MAKEEN FIRST, Riyadh (SA)

(72) Inventors: Anders BJØRN, Randers SV (DK); Niels Ole CEDERGAARD, Randers SV (DK); Chresten Bugge SKJØDT, Randers SV (DK); Ib Bech HANSEN, Randers SV (DK)

(21) Appl. No.: 18/863,509

(22) PCT Filed: May 9, 2023
(86) PCT No.: PCT/EP2023/062236

§ 371 Date: Nov. 6, 2024

(30) Foreign Application Priority Data
May 10, 2022 (EP) 22172541.9

(51) Int. Cl. C10B 53/07; C09C 1/48; C10B 47/44; C10B 57/08; C10G 1/02

(52) U.S. Cl. CPC C10B 53/07; C09C 1/48; C10B 47/44; C10B 57/08; C10G 1/02

(57) ABSTRACT

The invention relates to a pyrolysis system, such as a pyrolysis plant (100), for generating hydrocarbon compounds from a residual polymer product, such as a synthetic polymer, the system comprises5—a densifier (101) configured to receive and heat the residual polymer product, —a degas feeder configured to transfer the residual polymer product from the densifier, and wherein a pH regulating additive, such as Calcium Oxide (CaO), is added to the residual polymer product, —a degasser (102) configured to receive the residual polymer product from the 10 degas feeder, wherein the degasser comprises a degasser conveyor (112), such as a degasser screw conveyor, for moving the residual polymer product to a degasser exit (122a) and a heater for heating the residual polymer product to a temperature within a range from 240 to 280° C., and —a pyrolysis reactor (103) comprising an inlet (123a) configured to receive the 15 residual polymer product from the degasser, wherein the pyrolysis reactor (103) comprises at least one reactor conveyor (113) for moving solid parts of the residual polymer product towards a black carbon outlet (123b) and a heater for heating the residual polymer product to generate pyrolysis vapour, and wherein the pyrolysis reactor comprises a reactor vapour outlet (123c) for release of the 20 pyrolysis vapour comprising the hydrocarbon compounds.

### FIELD OF THE INVENTION

The invention relates to a pyrolysis system and in particular to a pyrolysis plant for converting plastic material, preferably waste plastic, into hydrocarbon products such as oil.

### BACKGROUND OF THE INVENTION

In order increase the amount of plastic waste that is recycled plastic can be recycled to make new plastic products. However, today only a minor fraction of plastic waste is directly recycled into new products and a major part of the plastic waste end in incineration plants, in landfills or in the nature.

Conversion of waste plastic into oil products by use of pyrolysis plants is known and many different pyrolysis plants have been suggested.

However, such known pyrolysis plants still suffer from problems that prevent them from large scale waste plastic handling.

Accordingly, there is a need for a pyrolysis plant that is capable of handling plastic waste in a large scale in an efficient and practical way.

US2016/0024390A1 discloses a dual stage, zone-delineated pyrolysis apparatus for the continuous conversion of hydro-carbonaceous materials to condensable, non-condensable and solid hydrocarbon products. The apparatus comprises at least one extruder capable of providing shear force and heat and having three or more treatment zones, a continuous process thermal kiln reactor, said extruder and said kiln reactor, which is in fluid communication, and means for transporting hydro carbonaceous materials through the apparatus. The hydro-carbonaceous materials are maintained within zones for a range of defined temperature and residence times, wherein the extruder has at least three zones, and the kiln reactor comprises at least two zones.

WO2019202546A1 discloses a pyrolysis plant for a thermic depolymerization of a plastic material. The plant includes a closed vessel of a reactor to which a feeder for a supply of the plastic material is connected and where the reactor's vessel has an output of gaseous products of the depolymerisation, has a mechanical mixer and an output for a removal of unevaporated heavier fractions. The feeder is adjusted for pressing of the plastic material and for its continuous movement to the reactor's vessel. The feeder is equipped by a heating of the plastic material and the feeder has a regulation of a flow of the outgoing plastic material pursuant to a level of the material in the reactor's vessel.

WO2022013712A1 discloses a method for pyrolysis of a mass of waste material. The method comprises providing a screw arrangement adapted to supply heat to the mass by mechanical shear, providing a reactor after the screw arrangement, adapted to supply heat to the mass in the absence of oxygen by heating the reactor wall, heating the mass to an exit temperature and increasing the pressure to an exit pressure in the screw arrangement, thermally degrading the mass in the reactor, wherein the mass is brought into an extreme condition at the exit temperature and exit pressure by the screw arrangement, such that during the pressure drop pyrolysis occurs, thereby forming gaseous hydrocarbons within the connecting element.

JP2000309781A discloses an apparatus an apparatus for continuous dry pyrolysis of plastics, particularly waste plastics. The apparatus comprises a compression unit, a melting unit, a first decomposition unit, a second decomposition unit, and a separation unit.

Whereas the above mentions publications discloses pyrolysis plants for processing waste plastic, the present invention has been devised with an aim of further improving such pyrolysis plants particularly with an aim of efficient and practical processing of plastic waste in a large scale.

### SUMMARY OF THE INVENTION

It is an object of the invention to provide an improved pyrolysis plant for converting waste plastic into hydrocarbon components, particularly to provide a solution that addresses the above mentions problems with existing pyrolysis plants and to provide an industrial scale pyrolysis plant.

In a first aspect of the invention there is provided a pyrolysis system, such as a pyrolysis plant, for generating hydrocarbon compounds from a residual polymer product, such as a synthetic polymer, the system comprises
a densifier configured to receive and heat the residual polymer product,
a degas feeder configured to transfer the residual polymer product from the densifier, and wherein a pH regulating additive, such as Calcium Oxide (CaO), is added to the residual polymer product,
a degasser configured to receive the residual polymer product from the degas feeder, wherein the degasser comprises a degasser conveyor, such as a degasser screw conveyor, for moving the residual polymer product to a degasser exit and a heater for heating the residual polymer product to a temperature within a range from 240 to 280° C., and
a pyrolysis reactor comprising an inlet configured to receive the residual polymer product from the degasser, wherein the pyrolysis reactor comprises at least one reactor conveyor for moving solid parts of the residual polymer product towards a black carbon outlet and a heater for heating the residual polymer product to generate pyrolysis vapour, and wherein the pyrolysis reactor comprises a reactor vapour outlet for release of the pyrolysis vapour comprising the hydrocarbon compounds.

The hydrocarbon compounds refer to hydrocarbon vapours and gasses that can be condensed in other parts of the pyrolysis plant into one or more hydrocarbon oils.

In this disclosure, the terms vapours, hydrocarbon vapours and gasses are used interchangeably. Thus, a vapour may equivalently refer to a gas, and vice versa. A vapour may comprise different liquids and solids in a gaseous phase and a gas may comprise substances in a vapour phase.

Advantageously, the process comprises three steps: 1) The residual polymer product such a waste plastic is initially heated and compressed in the densifier. The initial processing removes a substantial amount of water vapours unwanted chemical substances and heats the polymer product so that it reaches a viscosity so that it can be transported to the degasser without a complete melting of the polymer product. 2) The further heating in the degasser ensures that the polymer product is substantially melted. The heating within the range from 240 to 280° C. advantageously releases undesired vapours, chemicals and gasses such as corrosive vapours and gasses so that undesired gas-phase substances will not be captured in the pyrolysis oil and so that the downstream plant units can be manufactured from less corrosion-resistant metals. Furthermore, the temperature range from 240 to 280° C. may be low enough to avoid generation of desired hydrocarbon vapours so that the desired hydrocarbon vapours are only released in the pyrolysis reactor. A particular relevant degasser temperature may be 260° C. or substantially 260° C. or a temperature within a range from 255 to 265° C. The undesired volatiles may be released from the degasser via a degasser vapour outlet. The undesired gasses may be used for other purposes such as powering a gas motor or a fueling a gas boiler. 3) The screw conveyor based pyrolysis reactor enables a continuous pyrolysis of the melted residual polymer product and a continuous output of the black carbon outlet.

In the currently preferred embodiments, the reactor conveyor comprises at least one screw conveyor. However it is realised that any other suitable conveyor means may be used.

Advantageously, the degas feeder may comprise a heatable pipe, the heatable screw conveyor, and the densifier or at the entry region in the degas feeder there is provided an input for adding a pH regulating additive, preferably Calcium Oxide (CaO) to a flow of the residual polymer product. Advantageously, the Calcium Oxide is added as a process additive to reduce acidity of the polymer product and thereby reduce the risk of corrosion and in general to improve the process. By reducing the acidity it is realised that also the risk of clogging the pipes can be reduced since the crystallisation can be avoided of the products being processed in the pyrolysis plant. This also reduces the costs for process equipment as the amount of costly stainless steel components may be reduced. It is also realised by the invention that an enhanced effect of adding CaO is achieved by the time the additive is present in the system rather than the amount.

According to an embodiment, the densifier is arranged to heat the residual polymer product up to a temperature within 150 to 250° C., such as around 200° C. The initial heating is low enough to avoid generation of wanted gasses and high enough to enable compacting and changing the viscosity such as softening of the polymer product. The heating of the polymer product in the densifier may lead to melting a fraction of the polymer product, but does not lead a complete melting of the polymer product. The heating releases water and possibly some unwanted chemicals from the polymer product that can exit the densifier as water vapour via a vapour outlet for release of water vapour generated in the process of densifying residual polymer product. Hereby, oxidation of the pyrolysis oils produces later on in the process can be avoided. In a currently preferred embodiment, the densifier is configured for compacting the residual polymer product at a compression ratio of 2 to 3.5.

According to an embodiment, the degas feeder comprises a heatable pipe, an input for adding Calcium Oxide and/or a heatable screw conveyor for transferring the residual polymer product from the densifier to the degasser. Advantageously, the heated degas feeder enables transport of the heated and compressed residual polymer product over longer distances without the risk of clogging.

The degasser advantageously further comprises a degasser vapour outlet for release of undesired volatiles generated from the heating of the residual polymer product within the degasser. Preferably, the degasser is essentially horizontally oriented.

In the preferred embodiment of this disclosure, the degasser and the pyrolysis reactor are connected to each other by a pipe for establishing fluid communication between the lower portion of the degasser and the lower portion pyrolysis reactor. Furthermore, the pyrolysis reactor is arranged tilted so that the reactor screw conveyor will move solid parts of the residual polymer product from a lower portion to an elevated portion in the pyrolysis reactor, and where the black carbon outlet is placed at the uppermost portion of the pyrolysis reactor to receive the black carbon, from which outlet the black carbon exits by gravity and where a black carbon screw conveyor is arranged for transfer of the black carbon to a container.

Advantageously, degasser is essentially horizontally oriented and the tilting angle of the pyrolysis reactor is adjustable.

The pyrolysis reactor preferably comprises a plurality of reactor screw conveyors for moving solid parts of the residual polymer product towards the black carbon outlet. The plurality of reactor screw conveyors, such as two screw conveyors, are parallelly arranged in the reactor. This increases the capacity of the reactor and is moreover advantageous since only the screws are moving as heating preferably is provided as electric heating. so that the residual polymer product is heated in the pyrolysis reactor to an elevated temperature up to 500° C., such as a temperature within a range from 420 to 460° C.

By a pyrolysis plant according to the present disclosure it is advantageous since the pressure in the degasser and the pyrolysis reactor and the oil reactor is within the range of 0.1 to 1 bar, such as 0.2 to 0.45 bar.

According to an embodiment, the black carbon outlet is placed to receive the black carbon by gravity and a black carbon screw conveyor is arranged for transfer of the black carbon to a container. Advantageously, the black carbon has been separated from the liquid polymer product by the screw conveyor in the pyrolysis reactor so that the black carbon can be fall down to the black carbon outlet by gravity and thereby continuously be released from the pyrolysis reactor via the black carbon outlet. The black carbon screw conveyor advantageously enables a continuous transfer of the black carbon from the black carbon outlet to the black carbon container. Other black carbon transfer means than the black carbon screw conveyor may be used. It is also possible, the plant is configured so that the black carbon received by the black carbon outlet is passively transferred to the black carbon container by effect of the gravity. Accordingly, the black carbon screw conveyor may be dispensed with.

According to an embodiment, the pyrolysis reactor is arranged tilted so that the one or more reactor screw conveyors will move solid parts of the residual polymer product from a lower portion to an elevated portion of the reactor. Accordingly, due to the tilt, liquid components in the reactor from the pyrolysis will stay in the lower portion of the reactor and for further decomposition into pyrolysis vapours and/or gasses.

Advantageously, due to the tilted arrangement, the solid parts will be transported above the liquid level in the reactor. Therefore, the solid black carbon will be lifted by the screw conveyor to the elevated portion which is dry. It is an advantage that the thereby produced black carbon is dry or substantially dry when it leaves the pyrolysis reactor via the black carbon outlet. The black carbon can be used in various productions. The dry elevated portion is enabled by the tilted arrangement and by controlling the liquid level in the reactor, e.g. by controlling the inflow of the melted polymer product from the degasser to the pyrolysis reactor and/or by controlling the inflow of the residual polymer to the densifier. The inflow may be controlled based on a measurement of the liquid level in the pyrolysis reactor. Advantageously, the dry portion of the pyrolysis reactor enables continuous removal of black carbon from the reactor.

According to an embodiment, the pyrolysis reactor is configured with an adjustable tilt so that the tilt angle can be adjusted to achieve a variable height of an upper level of the residual polymer product in the reactor. For example, the adjustable tilt may be used during initial commissioning of the pyrolysis plant to find an optimal tilt angle for a given desired in-flow of the residual polymer product to the densifier or desired in-flow to the pyrolysis reactor. In this case, the adjustable tilt may be a configured as a manual tilt adjustment. However, the adjustable tilt may also be configured as a motorized, possibly an automatic feedback controlled tilt, wherein the tilt is adjustable dependent on measured conditions such as the inflow to the densifier, the pyrolysis reactor or the liquid level in the reactor or combinations thereof. By adjusting the tilt of the pyrolysis reactor and in particular where the degasser is oriented horizontally, the height level of the liquid residual polymer product in the pyrolysis reactor can be adjusted as well as the volume capacity and the size of the dry portion equivalent to the length of the dry portion of the pyrolysis screw conveyors

According to an embodiment, the pyrolysis plant comprises a controllable conveyor means, such as a controllable screw conveyor, for transferring the residual polymer product from the degasser to the pyrolysis reactor.

The controllable conveyor means may be controllable to control the flow rate of the residual polymer product, i.e. the in-flow to the pyrolysis reactor. For example, the in-flow may be controlled dependent on the liquid level in the pyrolysis reactor, the liquid level in the degasser, or both levels e.g. so as to achieve a certain ratio of the levels in the pyrolysis reactor and the degasser such as achieving equal or substantially equal levels.

According to an embodiment, the pyrolysis plant comprises an oil reactor arranged to separate the pyrolysis vapour received from the pyrolysis reactor into vapour components and liquid components, and wherein the oil reactor comprises one or more separator outlets for transfer of the vapour components to one or more reflux condensers and a liquid outlet for transfer of liquid components back to the pyrolysis reactor.

According to an embodiment, the oil reactor is configured to enable adjustment of a temperature within the separator according to a temperature set-point within a range from 350-450° C.

According to an embodiment, the oil reactor is configured to receive residual condensation products from a condensation of the pyrolysis vapour. For example, heavy non-evaporated hydrocarbon oils may be returned to the oil reactor for further cracking.

According to an embodiment, the pyrolysis plant further comprises one or more reflux condensers arranged to receive the vapour components from the oil reactor and to condense at least a fraction of the vapour components into liquid components. The one or more reflux condensers may comprise liquid outlets for transferring the liquid components back to the oil reactor.

According to an embodiment, the pyrolysis plant further comprises one or more raw pyrolysis oil (RPO) condensers arranged to receive the vapour components from the one or more reflux condensers and to condense at least a fraction of the vapour components into a heavier hydrocarbon liquid, such as a raw pyrolysis oil.

According to an embodiment, the pyrolysis plant comprises first and second reflux condensers and first and second raw pyrolysis oil condensers, wherein each one of the first and second raw pyrolysis oil condensers are arranged to receive vapour components from any one of the first and the second reflux condensers. Advantageously, by having redundant sets of pairs of a reflux condenser and a raw pyrolysis oil condenser, one set can be taken out of the process for cleaning while the other set is operated.

According to an embodiment, the plant comprises a naphtha condenser arranged to receive vapour components from the one or more raw pyrolysis oil condensers and to condense at least a fraction of the vapour components into a lighter hydrocarbon liquid, such as a naphtha liquid.

According to an embodiment, the pyrolysis plant further comprises a gas storage arranged to receive vapour comprising gasses from the plant. For example, the gas storage may receive vapour from the degasser vapour outlet and non-condensable vapour from the naphtha condenser. Advantageously, the vapour comprises gasses that can be used, e.g. in the pyrolysis plant, as an energy source e.g. for production of heat, steam or electricity. Accordingly, the pyrolysis plant may comprise a gas powered unit, such as a gas generator, configured to be fueled by gas from the gas storage. For example, the gas powered unit may be a gas turbine arranged to drive an electric generator or the gas powered unit.

According to an embodiment, the pyrolysis plant further comprises a boiling point corrector arranged to receive the heavier hydrocarbon liquid from the one or more raw pyrolysis oil condensers, wherein the boiling point corrector comprises a cascaded arrangement of re-boilers, wherein each re-boiler is arranged to heat the received liquid and transfer the generated vapour to a manifold tank and to transfer the remaining liquid to the next re-boiler in the cascaded arrangement of re-boilers and wherein the last re-boiler is arranged to transfer the remaining liquid back to the oil reactor.

A second aspect of the invention relates to a process for generating hydrocarbon compounds from a residual polymer product, such as a synthetic polymer, the method comprises
receiving, heating and compacting the residual polymer product in a densifier,
transferring the residual polymer product from the densifier to a degasser by a degas feeder, wherein a pH regulating additive, such as Calcium Oxide (CaO), is added to the residual polymer product, and
heating the residual polymer product in the degasser to a temperature within a range from 240 to 380° C., preferably 240 to 280° C., while the residual polymer product is moved by use of a degasser conveyor, such as a degasser screw conveyor, to a degasser exit,
transferring the residual polymer product from the degasser to a pyrolysis reactor, wherein solid parts of the residual polymer product are moved towards a black carbon outlet by use of at least one reactor conveyor, such as at least one screw conveyor, and wherein the residual polymer product is heated to generate pyrolysis vapour and releasing the pyrolysis vapour comprising the hydrocarbon compounds via a reactor vapour outlet of the pyrolysis reactor for further condensation of the pyrolysis vapour into a hydrocarbon oil product.

According to an embodiment wherein the pyrolysis reactor and the reactor screw conveyor is arranged tilted so that the at least one reactor screw conveyor moves solid parts of the residual polymer product from a lower portion to an elevated portion of the pyrolysis reactor, a level of liquid in the pyrolysis reactor is controlled so that the level of the liquid is below the elevated portion of the pyrolysis reactor.

For example, a conveyor means arranged to transfer the melted polymer product from the degasser to the pyrolysis reactor may be controlled to adjust the in-flow rate of the melted polymer to the pyrolysis reactor based on e.g. a measured liquid level in the pyrolysis reactor. Alternatively or additionally, a conveyor such as a belt conveyor suppling the residual polymer product to the densifier may be controlled based on the measure liquid level in the pyrolysis reactor to control the in-flow to the densifier and thereby the in-flow to the pyrolysis reactor.

A third aspect of the invention relates to use of the pyrolysis system according to the first aspect for generating hydrocarbon compounds from a residual polymer product.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a pyrolysis system according to a first embodiment,

FIGS. 2 and 3 show enlarged view of the pyrolysis system of FIG. 1, and

FIG. 4 is a schematic layout of a pyrolysis system according to a currently preferred, second embodiment.

### DETAILED DESCRIPTION

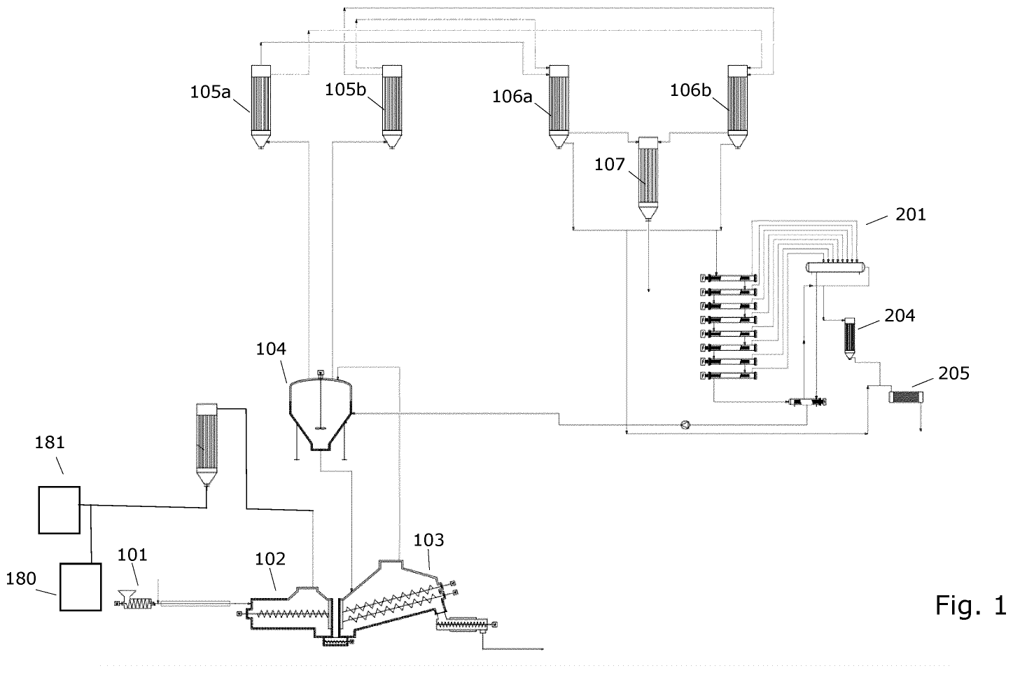

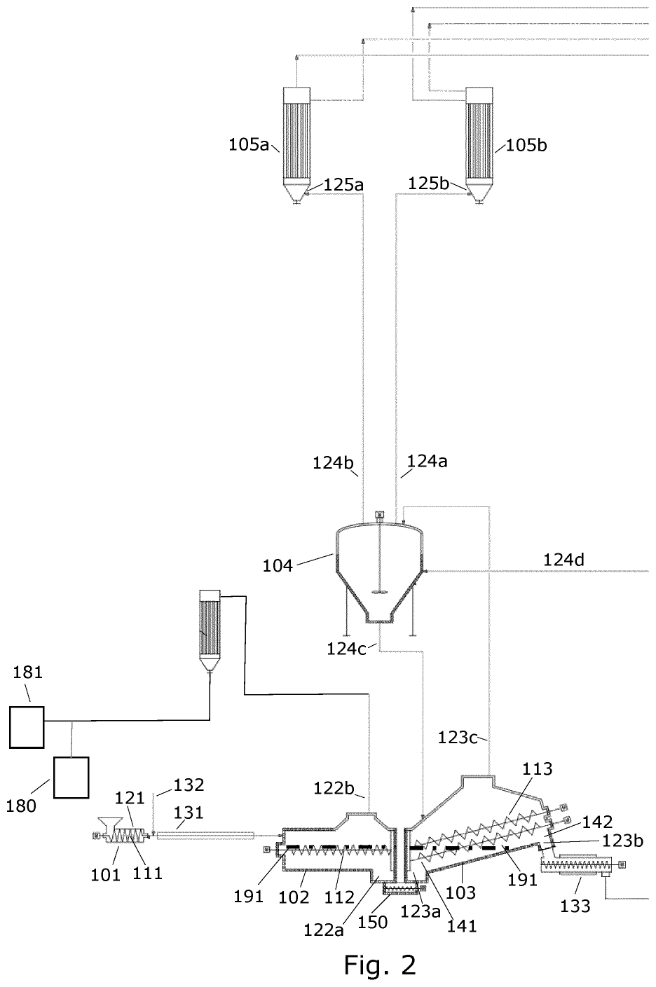

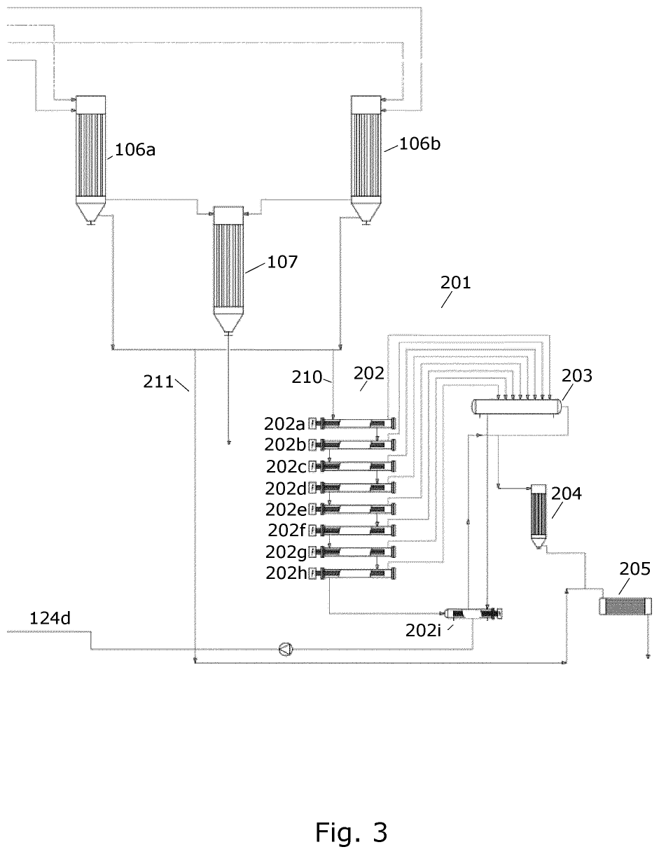

FIGS. 1, 2 and 3 show a pyrolysis plant 100 configured to generate hydrocarbon compounds from a residual polymer product. The residual polymer product refers in general to synthetic polymers. FIGS. 2 and 3 show the same components of the pyrolysis plant 100 as shown in FIG. 1 but in an enlarged view and with additional reference numbers.

Examples of the residual polymer product and equivalently the synthetic polymer product comprises, thermoplastic and other plastic material including processed products such as granulate from the synthetic polymer product. The residual polymer product may include multilayer plastic and compound plastic, i.e. products including different types of polymer products.

Examples of thermoplastic includes polyethylene, polypropylene, polyvinyl chloride, polystyrene, polyamides, polyesters, and polyurethanes, polyetherether ketones, liquid crystalline polymers, polysulfones, and polyphenylene sulfide and combinations thereof.

Advantageously, the residual polymer product may be a waste product, a used product or a recycled product. Thus, instead of disposing the waste product at a landfill site or burning the waste product, the synthetic polymer product may be processed into oil and gas. Thermoplastic products decomposes into a waste product and a vapour and gas mixture. This mixture can be processed in one or more condensers for condensing the vapour into an oil.

The generated hydrocarbon compounds comprises gas products and oil products such as raw pyrolysis oil, naphtha oil and marine gas oil.

The residual polymer product may be in the form of a mix of sorted different types of residual polymer products. The final residual polymer product mix may be mixed from pre-sorted polymer products so that the percentage of each product is within desired percentages or limited to maximum percentages. For example, the residual polymer product mix may be mixed to contain maximum percentages of polyethylene terephthalate (PET) and polyvinyl chloride (PVC). The percentages of different synthetic polymer products or plastics may be selected to achieve certain conditions in the pyrolysis process. Advantageously, the residual polymer product may include chloride, flour and terephthalate components.

The residual polymer product may contain contaminated waste plastic and is preferably shredded prior to the feeding into the densifier. The residual polymer product or sorted polymer product mix is fed to a densifier 101, e.g. by means of conveyor belts. The densifier compresses the residual polymer product. The compression may be achieved by one or more screw conveyors 111 comprised by the densifier 101. The compression generate heating of the residual polymer product due friction effects. The heating may result in that at least some of the polymer product melts, but the heating is sufficiently low so that substantial chemical reactions do not take place. However, the heating may cause generation of some water vapour from the polymer product. The densifier may be configured with a water vapour outlet 121 for release of the water vapour.

The densifier may be configured so that the residual polymer product is heated up to around 200° C., such as a temperature within a range from 150 to 200° C.

The compressed, heated and possibly partially melted polymer product is transferred to the degasser 102, e.g. via a heatable pipe 131 such as a pipe that is heat traced with thermal oil.

Alternatively or additionally, the polymer product from the densifier 101 may be transferred towards the degasser 102 by a screw conveyor which may be heated, e.g. by an electrical heater. For example, the transfer from the densifier 101 may include a heated screw conveyor connected in series with a heatable pipe 131 where the heatable pipe may be located downstream of the heated screw conveyor.

The degasser 102 comprises a screw conveyor 112 arranged to move the residual polymer product from an inlet to a degasser exit 122a. The degasser 102 comprises a heater such as an electrical heater for heating the residual polymer product to a temperature within a range from 240 to 280° C. A preferred output temperature of the melted residual polymer product at the degasser exit 122a may be a temperature within a range from 250 to 270° C., such as from 255 to 265° C. such as around 260° C. Thus, a temperature of 260° C. or other temperatures within the range from 240 to 280° C. may be set as a setpoint temperature which is controlled by a controller arranged to control the heater of the degasser 102. Temperature deviations from the setpoint temperature may occur such as temperature deviations of +/−1 to 2° C.

The heating in the degasser 102 causes vaporization of substantially all water content along with other volatiles and undesired volatiles as well as gasses, i.e. non-condensable gasses. Such undesired volatiles could contain undesired vapours such as corrosive gasses and vapours. The removal of such undesired volatiles may enable use of less corrosion resistant materials for the downstream components such as the pyrolysis reactor.

For the purpose of releasing the undesired volatiles and the remaining water vapour the degasser is configured with a degasser vapour outlet 122b.

The volatiles and gasses released from the degasser may be transferred to the storage tank 180. The released volatiles comprises a content of gasses such as syngas which can be used to fuel a gas powered unit 181 such as gas turbine or a boiler.

To improve the quality of the pyrolysis liquids that will be produced in the process Calcium Oxide (CaO) may be fed into the system as an additive/catalyst. For that purpose, the heatable pipe 131, alternatively, the densifier 101 is configured with an input 132 for adding Calcium Oxide to a flow of the residual polymer product, also referred to as the plastic pulp.

The melted residual polymer product is transferred from the degasser 102 to an inlet 123a of the pyrolysis reactor 103 via a pipe or optionally a conveyor means 150 such as screw conveyor, a piston or other conveyor means capable of performing a controlled transfer of the melted residual polymer. The conveyor means 150, preferably a screw conveyor, may be controlled dependent on measured liquid levels in the degasser and/or the pyrolysis reactor 103 to control the liquid level height 191 in the degasser 102 and/or the pyrolysis reactor 103. For example, the conveyor means 150 may be controlled, e.g. by controlling the speed and possibly the rotation direction of a screw conveyor, to actively level the liquid heights 191 in the degasser 102 and the pyrolysis reactor 103.

The pyrolysis reactor 103 comprises a reactor screw conveyor 113 for moving and mixing the residual polymer product towards a black carbon outlet 123b. The pyrolysis liquid in the reactor is heated by a heater such as an electrical heater for heating the residual polymer product to a temperature within a range from 420 to 500° C. to generate pyrolysis vapour. Upon heating the residual polymer product to a temperature above approx. 430° C. the residual polymer product will be chemically degraded to pyrolysis vapour, i.e. a mix of hydrocarbon compounds that will be in gas form at the given temperature. The pyrolysis vapour is released from the reactor 103 via a reactor vapour outlet 123c. The reactor vapour outlet 123c is advantageously located, e.g. midway along the length of the reactor screw conveyor 113, or at least away from the dry portion of the reactor to avoid dripping of the vapour onto the dried black carbon.

Towards the end of the reactor screw conveyor 113 substantially all of the residual polymer product will have been decomposed and a solid fraction comprising black carbon residue will leave the process in the end of the reactor. The black carbon is transported out of the reactor via the black carbon outlet 123b placed in the reactor to receive the black carbon by gravity. The plant 100 may comprise a black carbon screw conveyor 133 arranged in extension of the black carbon outlet 123b for transferring the black carbon to a container.

The solid fraction comprising the black carbon of the residual polymer is generated in the pyrolysis reactor 103 by the chemical decomposition.

Liquids from the oil reactor (i.e. the heaviest fraction of the pyrolysis vapor) is fed to the bottom of the pyrolysis reactor, to facilitate further decomposition of these compounds.

The pyrolysis reactor 103 is arranged tilted so that the reactor screw conveyor will move at least solid parts of the residual polymer product from a lower portion 141 proximate to the inlet 123a to an elevated portion 142 of the reactor proximate to the black carbon outlet 123b. Thus, the tilt of the reactor implies that the reactor screw conveyor is arranged tilted, i.e. so that the one end of the screw conveyor proximate to the inlet 123a is located lower relative to a horizontal plane than the other end of the screw conveyor proximate to the black carbon outlet 123b.

The tilt angle of the pyrolysis reactor 103 and reactor screw conveyor 123 is in the range from 5 to 35 degrees, such as 15 to 25 degrees, preferably approx. 20 degrees relative to horizontal.

The solid black carbon is moved upwards along the reactor screw conveyor 123 towards the black carbon outlet 123b while liquid components from the pyrolysis move towards the lower portion proximate to the inlet 123a of the reactor for further decomposition into pyrolysis vapours. The reactor screw conveyor 123 may be configured with holes in the flanges of the screw part to facilitate easier transfer of liquid components to the lower portion 141 while heavier solid parts will be moved upwards by the outer portion of the screw flanges which do not have holes.

FIG. 2 shows an example wherein the liquid level 191 is indicated. In this example, the liquid level 191 is substantially the same in the degasser 102 and the pyrolysis reactor 103. Due to the tilt of the pyrolysis reactor 103, the elevated portion 142 of the reactor is dry and therefore the black carbon will be dry or substantially dry at the elevated portion 142 and can thereby be released from the pyrolysis reactor as dried black carbon. The portion above the liquid portion where the reactor is dry is referred to as a dry portion of the pyrolysis reactor 103. The dry portion is therefore associated with a length of the pyrolysis screw conveyor, i.e. the final portion of the pyrolysis screw conveyor, which is above the liquid level.

The tilt of the pyrolysis reactor may be adjustable so that the tilt angle can be adjusted. By adjusting the tilt, the height level of the liquid residual polymer product in the pyrolysis reactor 103 can be adjusted as well as the volume capacity and the size of the dry portion equivalent to the length of the dry portion of the pyrolysis screw conveyors.

For example, if due to a low input flow of the residual polymer product or a fast processing of the residual polymer product into pyrolysis vapours, the height level of the liquid residual polymer product will become low and therefore lead to a corresponding low height level of the residual polymer product in the degasser 102 which may be too low for efficient processing in the degasser, i.e. the level in the degasser should be high enough to enable the degasser screw conveyor 112 to mix and transport the residual polymer product. If this is the case, the tilt may be increased to decrease the volume capacity in the pyrolysis reactor and thereby increase the height of the liquid level in the pyrolysis reactor. Since the fluid in the vessels of the degasser 102 and the pyrolysis reactor 103 is able to flow between the vessels via the conveyor means 150, the fluid in the vessels behaves as the fluid in connected vessels. Therefore, by increasing the tilt angle, the liquid height in the pyrolysis reactor 103 would increase and lead to a flow back to the degasser 102 so that the liquid level in the degasser also increases until an equilibrium has been reached.

If the upper level of the liquid residual polymer product in the pyrolysis reactor is too high the dry portion may become too small. Thus, if the level in the pyrolysis reactor 103 is too high, the tilt angle can be increased to decrease the volume capacity. Even though this leads to an increased height of the liquid level, the dry portion is elevated so that the dry portion is maintained or increased. Oppositely, if the dry portion becomes too large the tilt angle can be decreased to lower the elevation of the dry portion and thereby decrease the length of the dry portion of the pyrolysis screw conveyor

The pyrolysis vapors exit the pyrolysis reactor 103 through a pipe via the reactor vapour outlet 123c in the top of the reactor and is transferred directly to the oil reactor 104.

The oil reactor 104 is a tank arranged to separate the pyrolysis vapour received from the pyrolysis reactor 103 into vapour components and liquid components. In the oil reactor 104 any black carbon is also separated and fed back to the pyrolysis reactor together with the liquid component.

The oil reactor 104 may comprise an agitator for mixing the content. The pyrolysis vapors enters via a nozzle in the top and by a dip pipe into the liquid phase in the tank. The tank temperature is adjustable within a temperature range of 350-450° C. For example, a temperature control system may be provided to control the tank temperature according to a temperature setpoint. The temperature in the oil reactor 104 can be controlled by a combination of controlling heating of the condensed liquid in the separator, e.g. by an electrical heater.

In addition to the pyrolysis vapours, the oil reactor 104 may be configured to receive residual condensation products from a condensation of the pyrolysis vapour via the pipe connection 124d. Such residual condensation products include liquid products from reactor feed tank 202i.

Liquids from oil reactor 104 is transferred back to the pyrolysis reactor 103 via a liquid outlet 124c for further decomposition into pyrolysis vapours.

The oil reactor 104 comprises two separator outlets 124a, 124b for transfer of the vapour components to two reflux condensers 105a, 105b via respective pipes. The same pipes will lead condensed liquids from the reflux condensers 105a, 105b back to the oil reactor 104 via liquid outlets 125a, 125b of the reflux condensers. These liquid outlets therefore also functions as vapour inlets.

The reflux condensers 105a, 105b are arranged to condense at least a fraction of the vapour components from the oil reactor 104 into liquid components. The two reflux condensers may be configured as shell and tube heat exchangers with pyrolysis vapors on the tube side and thermal oil on the shell side where heat is transferred upon condensation of the pyrolysis vapors to the thermal oil side.

In a configuration of the pyrolysis plant 100 the reflux condensers 105a, 105b are dimensioned so that only one of them may be operated at a time, i.e. each of the reflux condensers is dimensioned according to 100 percent capacity to match the capacity of the pyrolysis reactor 103. Therefore, it is possible to clean one of the reflux condensers while the other is operating.

Accordingly, each of the reflux condensers may be configured so that they can be isolated/disconnected from the pyrolysis process. The cleaning may be performed by mechanical and/or steam cleaning as precipitation of various components such as crystals generated by PET and/or wax may be generated in the reflux condensers.

The supply of thermal oil for cooling of the pyrolysis vapors in the reflux condensers 105a, 105b may be controlled based on the temperature of the vapor discharge from the reflux condensers, i.e. the temperature of the pyrolysis vapor exiting the reflux condensers and supplied to downstream raw pyrolysis oil condensers 106a, 106b. The temperature control setpoint of the exit vapour may for example be approximately 250° C. However, the setpoint temperature of the reflux condensers may be adjustable to achieve desired properties of the produced hydrocarbon compounds of the plant.

Furthermore, the thermal oil system of the reflux condensers can be used to preheat the reflux condensers 105a, 105b to ensure the right process temperature when the pyrolysis process starts in a cold start-up of the plant 100 or when a previously non-operated reflux condenser 105a in included in the process after a cleaning process.

The plant may alternatively be configured with only one reflux condenser 105a or a plurality of reflux condensers arranged to operate in parallel.

The pyrolysis vapour released by the one or more reflux condensers 105a is condensed in downstream raw pyrolysis oil condensers 106a, 106b and a naphtha condenser 107.

The raw pyrolysis oil condensers 106a, 106b may be configured as shell and tube heat exchangers with pyrolysis vapors on the tube side and thermal oil on the shell side. Heat is transferred upon the partial condensation of the pyrolysis vapors to a liquid phase of a Marine Gas Oil (MGO).

Similarly to the reflux condensers 105a, 105b, the raw pyrolysis oil condensers 106a, 106b are dimensioned so that only one of them may be operated at a time, i.e. each of the raw pyrolysis oil condensers is dimensioned with 100 percent capacity to match the capacity of the pyrolysis reactor 103 and the one or more reflux condensers. Accordingly, it may be sufficient to operate only one of the raw pyrolysis oil condensers while the other is taken out of operation, e.g. for cleaning purposes. Accordingly, each of the raw pyrolysis oil condensers 106a, 106b may be configured so that they can be isolated/disconnected from the pyrolysis process. However, this is only an exemplary configuration and the pyrolysis plant 100 may alternatively be configured with only one raw pyrolysis oil condenser 105a or a plurality of raw pyrolysis oil condensers 106a, 106b arranged to operate in parallel.

In a redundant configuration of the pyrolysis plant 100 the first and second reflux condensers 105a, 105b and first and second raw pyrolysis oil condensers 106a, 106b are connected via pipes and closing valves to enable each one of the first and second raw pyrolysis oil condensers to be fluidly connected with any one of the first and second reflux condensers, i.e. so that each of the first and second raw pyrolysis oil condensers 106a, 106b can receive vapour components from each one of the first and the second reflux condensers 105a, 105b.

The supply of thermal oil for cooling of the pyrolysis vapors in the raw pyrolysis oil condensers 106a, 106b may be controlled based on the outlet temperature of the vapor discharge of the raw pyrolysis oil condensers 106a, 106b. The controllable set point temperature of the outlet temperature may be in the range of 100° C. to 180° C. such as from 130 to 180° C., depending on desired oil properties.

The pyrolysis vapors from the raw pyrolysis oil condensers 106a, 106b are transferred to the naphtha condenser 107. The naphtha condenser may be a shell and tube heat exchanger with pyrolysis vapors on the tube side and chilled water on the shell side. The pyrolysis vapors enter the exchanger at a temperature of 130-180° C. and are cooled and condensed to a temperature of approximately 20° C.

The temperature of the supplied chilled water for the naphtha pyrolysis oil (NPO) condenser 107 may be controlled based on the temperature in the outlet of naphtha from the naphtha pyrolysis oil condenser. The setpoint temperature at the outlet of the naphtha pyrolysis oil condenser may be a temperature in the range from 20-30° C. such as 20° C.

The naming of the raw pyrolysis oil and naphtha pyrolysis oil condensers 106a, 106b, 107 does not imply that the raw pyrolysis oil condensers 106a, 106b are limited to produce raw pyrolysis oil and that the naphtha pyrolysis oil condenser is limited to produce naphtha. In general, the raw pyrolysis oil (RPO) and naphtha pyrolysis oil (NPO) condensers 106a, 106b, 107 may be operated so that the raw pyrolysis oil condensers 106a, 106b produce heavier oils, such as C12-C45 oils, and the naphtha pyrolysis oil (NPO) condenser 107 produce lighter oils, such as C5-C12 oils, but the raw pyrolysis oil and naphtha condensers 106a, 106b, 107 may be operated to produce other groups of the hydrocarbons C1-C45 processed by the plant 100. Accordingly, the raw pyrolysis oil condensers may equivalently be referred to as heavy oil condensers and the naphtha condensers may equivalently be referred to as light oil condensers.

The pyrolysis plant 100 further comprises a gas storage tank 180 which is fluidly connected (not shown) to the degasser 102 for receiving vapour from the degasser vapour outlet 122b and fluidly connected to the naphtha condenser 107 for receiving and non-condensable gases from the naphtha condenser 107 (not shown). The gas, which may be referred to as syngas, stored in the gas storage tank 180 may be used to fuel and run a gas turbine which drives an electric power generator or the gas may be used to fuel a gas driven boiler or steam generator. Electric power generated based on the gas from the pyrolysis plant may be used to power electric power consumers of the power plant 100 such as the electric heaters. Steam from a boiler may be used for heating processes in the plant 100.

The pyrolysis plant 100 may further comprise a raw pyrolysis oil (RPO) storage tank (not shown) for receiving and storing condensed liquid from the raw pyrolysis oil condensers 106a, 106b. The raw pyrolysis oil storage tank may comprise heating means arranged to maintain or raise the temperature of the incoming liquids slightly. The normal operating temperature in the raw pyrolysis oil storage tank may be in the temperature range 130-180° C. The raw pyrolysis oil tank may have a vapor outlet connected to the vapor outlet of the raw pyrolysis oil condensers 106a, 106b which balances the pressures.

The pyrolysis plant 100 may further comprise a naphtha (NPO) storage tank (not shown) for receiving and storing condensed liquid from the naphtha condenser 107. In an embodiment, the RPO and NPO are stored in the same tank.

Optionally, the pyrolysis plant may comprise a boiling point corrector 201 arranged to receive the condensed liquid from the one or more raw pyrolysis oil condensers 106a, 106b via a pipe branch 210. The boiling point corrector 201 comprises a cascade arrangement of re-boilers 202 arranged to gradually heat the liquid, e.g. from a temperature at the output of the raw pyrolysis oil condenser such as a temperature within the 130-180° C. range up to 300° C. such as up to 450° C., or in general from a temperature of 100° C. to 450° C. The re-boilers comprise a heating element arranged to heat the received liquid. The first re-boiler 202a receives the condensed liquid from the one or more raw pyrolysis oil condensers 106a, 106b. The first re-boiler 202a heats the liquid up to a first temperature T1, e.g. 130° C. The generated vapour from the first boiler 202a is transferred to a manifold tank 203 and the remaining liquid is transferred to second re-boiler 202b. The second re-boiler 202b heats the liquid from the first re-boiler 202a up to a second temperature T2, with T2>T1. The generated vapour from the second boiler 202b is transferred to the manifold tank 203 and the remaining liquid is transferred to a third re-boiler 202c. The subsequent downstream one or more re-boilers 202d-202h are configured in the same way as the previous upstream boilers, but with increasing boiling temperatures T3-T8. The ninth and last boiler 202i heats the liquid from the previous boiler 202h up to a final temperature Tf, with Tf>T8, e.g. Tf=450° C. The generated vapour from the last boiler 202i is transferred to the manifold tank 203 and the remaining liquid is transferred back to the oil reactor 104 via the pipe connection 124d. The vapour in the manifold tank 203 is transferred to the condenser 204 and the condensed liquid from the condenser 204 is transferred to a sub-cooler 205 for cooling to a suitable temperature, e.g. 20° C.

The boiling point corrector 201 is optional but may be included to produce an oil with an adjusted boiling point. For example, the heavier oils produced by the raw pyrolysis oil condensers 206a, 206b may have a boiling point within 450 to 550° C., such as 500° C. If needed, the boiling point corrector 201 can be used to reduce the boiling point to a temperature within 400 to 450° C., such as around 410° C.

FIG. 3 shows a first pipe branch 210 connecting the raw pyrolysis oil condensers 106a, 106b with the boiling point corrector 201 and a second pipe branch 211 connecting the raw pyrolysis oil condensers 106a, 106b directly to the sub-cooler 205. In a configuration of the pyrolysis plant which includes the boiling point corrector 201, valves are provided to select either the first or the second pipe branch 210, 211.

It is noted that the oil condensers may be arranged in other ways than shown in FIG. 1. For example, the naphtha condenser 107 may be arranged in series with the redundant raw pyrolysis oil condensers 106a, 106b to cool the previous condensed raw pyrolysis oil and condense the naphtha vapors in order to produce raw pyrolysis oil instead of raw pyrolysis oil and naphtha.

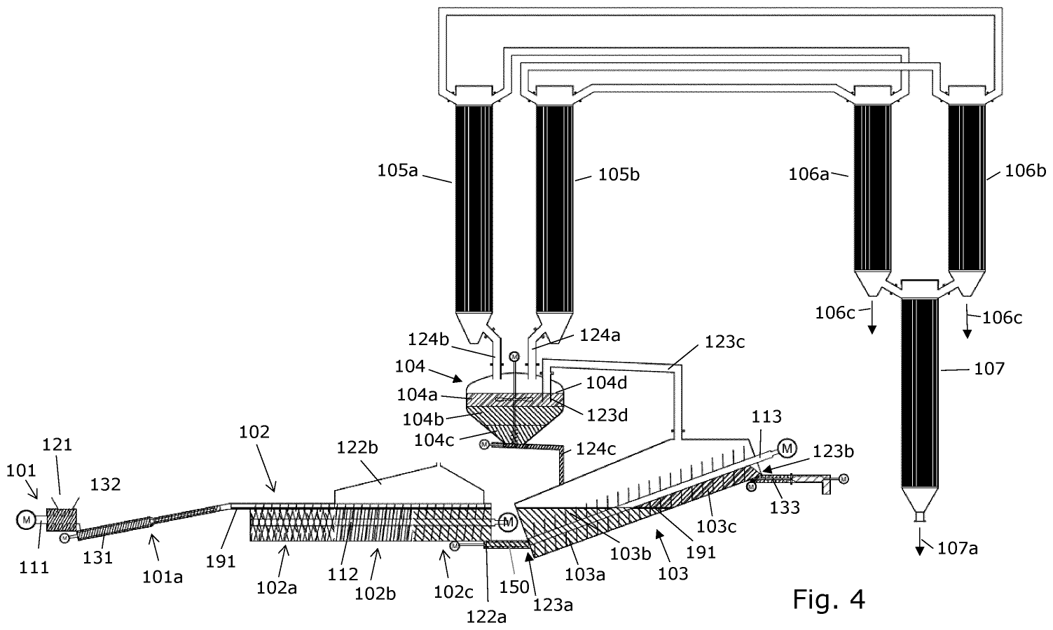

In FIG. 4, a further embodiment of the pyrolysis plat according to the invention is shown, where elevation and mutual size of the reactors and condensers is according to the currently preferred embodiment of the pyrolysis plant.

Like the plant shown in FIGS. 1 to 3, the residual polymer product is fed to a densifier 101 wherein the product is compressed, preferably at a ratio of 2-3.5 by screw conveyors 111. A vapour outlet 121 is provided to release water vapour released from the residual polymer products being compressed. By removing the water vapour, vapour explosions in the system may be avoided as well as it is avoided that the pyrolysis oil produced is being oxidized. The compressed residual polymer product is forwarded through a degas feeder 101a, where a pH regulating additive, preferably Calcium Oxide (CaO), is added through an inlet 132 at the entry region in the degas feeder 101a. The Calcium Oxide is then mixed with the residual polymer product quickly in the degas feeder 101a. During the travel through the degas feeder the residual polymer product is heated in a heatable pipe 131. In s first section the product is heated to 180-220° C. and in a second section further heated to approx. 200-280° C. The residual polymer product is then fed into the degasser 102. In the degasser 102 the residual polymer product is moved substantially horizontally by a screw conveyor 112 through three heating zones 102a, 102b and 102c. In the degasser 102, the zones heat the media, i.e. the residual polymer product, up to max. 240° C. in the first zone 102a, and heat the media up to max. 260° C. in the second zone 102b and up to max. 280° C. in the third zone 102c. A gas outlet 122b is provided above at least the zones 102b and 102c as shown in the FIG. 4. Inside the degasser 102 the pressure is within the range of 0.1 to 1 bar, such as 0.2-0.45 bar.

The residual polymer product, also referred to as the media or plastic pulp is then transferred to the pyrolysis reactor 103 through a pipe conveyor 150. The degasser, which is horizontally oriented, and the pyrolysis reactor, which is tilted upwards, are connected so there is a fluid communication between the outlet 122a at the bottom of the degasser 102 and the inlet 123a at the lowermost region of the tilted pyrolysis reactor 103. As indicated in FIG. 4 the liquid level 191 is about the same as described above with reference to FIG. 2.

The pyrolysis reactor 103 comprises two screw conveyors 113, preferably arranged in parallel hence only one is shown in FIG. 4. The screw conveyors 113 are conveying the residual polymer product and mixing the product whilst lifting upwards and out of the liquid level towards a black carbon outlet 123b at the top of the reactor 103. The pyrolysis liquid in the reactor 103 is heated by a heater such as an electrical heater for heating the residual polymer product to a temperature of up to max. 500° C. to generate pyrolysis vapour. The heating can be arranged in heating zones. The pressure inside the pyrolysis reactor 103 is similar to the pressure of the degasser, i.e. 0.1 to 1 bar, such as 0.2-0.45 bar.

The pyrolysis vapour is released from the reactor 103 via a reactor vapour outlet 123c. The reactor vapour outlet 123c is away from the dry portion of the reactor to avoid dripping of any condensed vapour onto the dried black carbon. Towards the end of the reactor screw conveyors 113 substantially all of the residual polymer product will have been decomposed and a solid fraction comprising black carbon residue will leave the process in the end of the reactor 103. The black carbon is transported out of the reactor 103 via the black carbon outlet 123b placed in the reactor to receive the black carbon. At the outlet 123b a black carbon screw conveyor 133 may be arranged in extension of the black carbon outlet 123b for transferring the black carbon to a container. Advantageously, also a gas lock valve (not shown) may be provided to ensure that no gasses escape through the black carbon outlet 123b.

The pyrolysis vapour released from the reactor 103 via a reactor vapour outlet 123c is fed into the oil reactor 104. The oil reactor 104 functions as a vapour-liquid separator. The reactor vapour outlet pipe 123c is positioned in the oil reactor 104 such that the pipe exit 123d is below the liquid level 104d in the oil reactor 104. The oil reactor 104 is heated in three zones 104a, 104b and 104c as indicated in FIG. 4. In each zone the pyrolysis vapour product is heated to max. 450° C. The pyrolysis vapour is released into the oil reactor 104 below the liquid level as shown in the FIG. 4. If the product liquefies in the oil reactor 104 and fall to the bottom thereon, this heavy oil and any solid particles is returned to the pyrolysis reactor 103 via the pipe 124c for further decomposition in the pyrolysis reactor 103.

In the top of the oil reactor 104 two outlets 124a, 124b are provided for transferring vapour components to the two reflux condensers 105a, 105b. All the pyrolysis vapour enters at the bottom of each of the reflux condensers 105 and exits at the top of the reflux condensers 105a, 105b with a temperature of max. 260° C. From the top of the reflux condensers 105a, 105b, the pyrolysis vapour is led to the raw pyrolysis oil (RPO) condensers 106a and 106b, where the vapour is condensed to heavy products (Raw Pyrolysis Oil or RPO) with an outlet temperature of approx. 150-180° C. Furthermore, pyrolysis vapours are transferred to the Nafta Pyrolysis Oil condenser 107, in which the vapours are condensed and chilled and exits as a light product at a temperature of 10-35° C.

1. A process for generating hydrocarbon compounds from a residual polymer product, such as a synthetic polymer, the method comprises
receiving, heating and compacting the residual polymer product in a densifier (101),
transferring the compressed residual polymer product from the densifier to a degasser (102) through a degas feeder (101a) and therein
adding a pH regulating additive, such as Calcium Oxide (CaO), to the compressed residual polymer product, and
heating the residual polymer product in the degasser (102) to a temperature within a range from 240 to 380° C., preferably 240 to 280° C., while the residual polymer product is moved by use of a degasser conveyor (112), such as a screw conveyor, to a degasser exit (122a),
transferring the residual polymer product from the degasser to a pyrolysis reactor (103), wherein solid parts of the residual polymer product are moved towards a black carbon outlet (123b) by use of at least one reactor conveyor (113), such as at least one screw conveyor, and wherein the residual polymer product is heated to generate pyrolysis vapour and releasing the pyrolysis vapour comprising the hydrocarbon compounds via a reactor vapour outlet (123c) of the pyrolysis reactor for further condensation of the pyrolysis vapour into a hydrocarbon oil product, and
separating in an oil reactor (104) the pyrolysis vapour received from the pyrolysis reactor (103) into vapour components and liquid components, and wherein the oil reactor (104) comprises one or more separator outlets (124b) transferring the vapour components to one or more reflux condensers (105a, 105b) and a liquid outlet (124c) transferring liquid components back to the pyrolysis reactor (103).

2. A process according to claim 1, wherein the pyrolysis reactor is arranged tilted so that the reactor screw moves solid parts of the residual polymer product from a lower portion to an elevated portion of the pyrolysis reactor, and wherein a level of liquid in the pyrolysis reactor is controlled so that the level of the liquid is below an elevated portion of the pyrolysis reactor.

3. A process according to claim 1, wherein the degasser (102) is essentially horizontally oriented.

4. A pyrolysis system, such as a pyrolysis plant (100), for generating hydrocarbon compounds from a residual polymer product, such as a synthetic polymer by performing a process according to claim 1, the system comprising
a densifier (101) configured to receive heat and compact the residual polymer product,
a degas feeder (101a) configured to transfer the compacted residual polymer product from the densifier, and wherein a pH regulating additive, such as Calcium Oxide (CaO), is added to the compacted residual polymer product,
a degasser (102) configured to receive the residual polymer product from the degas feeder, wherein the degasser (102) comprises a degasser conveyor (112), such as a degasser screw conveyor, for moving the residual polymer product to a degasser exit (122a) and a heater for heating the residual polymer product to a temperature within a range from 240 to 280° C., and
a pyrolysis reactor (103) comprising an inlet (123a) configured to receive the residual polymer product from the degasser, wherein the pyrolysis reactor (103) comprises at least one reactor conveyor (113) for moving solid parts of the residual polymer product towards a black carbon outlet (123b) and a heater for heating the residual polymer product to generate pyrolysis vapour, and wherein the pyrolysis reactor comprises a reactor vapour outlet (123c) for release of the pyrolysis vapour comprising the hydrocarbon compounds, and
wherein the pyrolysis plant (100) further comprises an oil reactor (104) arranged to separate the pyrolysis vapour received from the pyrolysis reactor (103) into vapour components and liquid components, and wherein the oil reactor (104) comprises one or more separator outlets (124b) for transfer of the vapour components to one or more reflux condensers (105a, 105b) and a liquid outlet (124c) for transfer of liquid components back to the pyrolysis reactor (103).

5. A system according to claim 4, wherein the reactor conveyor comprises at least one screw conveyor.

6. A system according to claim 4, wherein the densifier comprises an outlet for release of water vapour generated in the process of densifying residual polymer product.

7. A system according to claim 4, wherein the densifier is configured for compacting the residual polymer product at a compression ratio of 2 to 3.5.

8. A system according to claim 4, wherein the degas feeder comprises a heatable pipe (131), an input (132) for adding Calcium Oxide and/or a heatable screw conveyor for transferring the residual polymer product from the densifier to the degasser.

9. A system according to claim 4, wherein the degasser (102) comprises a degasser vapour outlet (122b) for release of undesired volatiles generated from the heating of the residual polymer product within the degasser.

10. A system according to claim 4, wherein the degasser (102) and the pyrolysis reactor (103) are connected to each other by a pipe for establishing fluid communication between the lower portion of the degasser (102) and the lower portion pyrolysis reactor (103).

11. A system according to claim 4, further comprising a conveyor means (150) for transferring the residual polymer product from the degasser (102) to the pyrolysis reactor (103), wherein the conveyor means (150) is controllable to control a flow rate of the residual polymer product.

12. A system according to claim 4, wherein the degasser (102) is essentially horizontally oriented.

13. A system according to claim 4, wherein the pyrolysis reactor (103) is arranged tilted so that the reactor screw conveyor will move solid parts of the residual polymer product from a lower portion (141) to an elevated portion (142) in the pyrolysis reactor.

14. A system according to claim 13, wherein the degasser is essentially horizontally oriented and the tilting angle of the pyrolysis reactor (103) is adjustable.

15. A system according to claim 4, wherein the pyrolysis reactor (103) comprises a plurality of reactor screw conveyors (113) for moving solid parts of the residual polymer product towards the black carbon outlet (123b).

16. A system according to claim 4, wherein the residual polymer product is heated in the pyrolysis reactor (103) to an elevated temperature up to 500° C., such as a temperature within a range from 420 to 460° C.

17. A system according to claim 4, wherein the black carbon outlet (123b) is placed at the uppermost portion of the pyrolysis reactor (103) to receive the black carbon, and from said outlet the black carbon exits by gravity and where a black carbon screw conveyor (133) is arranged for transfer of the black carbon to a container.

18. A system according to claim 4, wherein the pressure in the degasser and the pyrolysis reactor and the oil reactor is within the range of 0.1 to 1 bar, such as 0.2 to 0.45 bar.

19. A system according to claim 4, wherein the pyrolysis plant (100) further comprises one or more reflux condensers (105a, 105b) arranged to receive the vapour components from the oil reactor (104) and to condense at least a fraction of the vapour components into liquid components.

20. A system according to claim 19, wherein the pyrolysis plant further comprises one or more raw pyrolysis oil condensers (106a, 106b) arranged to receive the vapour components from the one or more reflux condensers and to condense at least a fraction of the vapour components into a heavier hydrocarbon liquid, such as a raw pyrolysis oil liquid.

21. A system according to claim 4, wherein the plant comprises first and second reflux condensers (105a, 105b) and first and second raw pyrolysis oil condensers (106a, 106b), wherein each one of the first and second raw pyrolysis oil condensers are arranged to receive vapour components from any one of the first and the second reflux condensers.

22. A system according to claim 20, wherein the plant comprises a naphtha condenser (107) arranged to receive vapour components from the one or more raw pyrolysis oil condensers and to condense at least a fraction of the vapour components into a lighter hydrocarbon liquid, such as a naphtha liquid.

23. A system according to claim 4, further comprising a gas storage (180) arranged to receive vapour comprising gasses from the plant.

24. A system according to claim 4, further comprising a boiling point corrector (201) arranged to receive the heavier hydrocarbon liquid from the one or more raw pyrolysis oil condensers (106a, 106b), wherein the boiling point corrector (201) comprises a cascaded arrangement of re-boilers (202a-202i), wherein each re-boiler is arranged to heat the received liquid, to transfer the generated vapour to a manifold tank (203) and to transfer the remaining liquid to the next re-boiler in the cascaded arrangement of re-boilers and wherein the last re-boiler (202i) is arranged to transfer the remaining liquid back to the oil reactor (104).
